(19) United States
(12) Patent Application Publication
(10) Pub. No.: US 2013/0041635 A1
(43) Pub. Date: Feb. 14, 2013

(54) Methods and Systems for Designing Addendum Section of A Die in Sheet Metal Forming

(71) Applicants: Xinhai Zhu, Pleasanton, CA (US); Philip Ho, Livermore, CA (US); Li Zhang, Rochester Hills, MI (US)

(72) Inventors: Xinhai Zhu, Pleasanton, CA (US); Philip Ho, Livermore, CA (US); Li Zhang, Rochester Hills, MI (US)

(73) Assignee: LIVERMORE SOFTWARE TECHNOLOGY CORPORATION, Livermore, CA (US)

(21) Appl. No.: 13/208,238

(22) Filed: Aug. 11, 2011

(51) Int. Cl. G06F 17/50

(52) U.S. Cl. 703/2

(57) ABSTRACT

An improved method of creating a computerized numerical model representing addendum section is disclosed. Computerized numerical model is created by placing a plurality of surface patches at disjoint locations along an enclosed trim line of the product design surface and corresponding binder opening line. Each surface patch is bounded with top and bottom edges coincided with the enclosed trim line and the binder opening line, respectively. Each surface patch is further bounded with two side edges connecting corresponding ends of the top and bottom edges. To ensure a continuously smooth transition between the product design surface and the binder surface, a number of parameters are adjusted for each surface patch to obtain a desired surface geometry. Any gap between a neighboring pair of surface patches is filled with a filler patch using a blending procedure that ensures continuous smooth transition from two neighboring side edges of the neighboring pair.

### FIELD OF THE INVENTION

The present invention generally relates to sheet metal forming, more particularly to methods and systems for designing a die's addendum section in sheet metal forming process.

### BACKGROUND OF THE INVENTION

Sheet metal forming has been used in the industry for years for creating metal parts from a blank sheet metal, for example, automobile manufacturers and their suppliers produce many of the parts using sheet metal forming.

One of the most used sheet metal forming processes is drawing, which involves a hydraulic or mechanical press pushing a specially-shaped punch into a matching die with a piece of blank sheet metal in between. Exemplary products made from this process include, but are not limited to, car hood, fender, door, automotive fuel tank, kitchen sink, aluminum can, etc. In some areas of the die, the depth of a part or product being made is generally more than half its diameter. As a result, the blank is stretched and therefore thinned in various locations due to the geometry of the part or product. The part or product is only good when there is no structural defect such as material failure (e.g., cracking, tearing, wrinkling, necking, etc.). In order to produce a part free of these defects, it is critical to design an addendum section between the product design and the binder region. FIG. 1 is a diagram illustrating an elevation view of cross-section of an exemplary set up of a draw die for sheet metal forming.

Shown in FIG. 1, a blank 120 (i.e., an unformed sheet metal plate before being formed) is rest on a blank holder 108 between an upper die cavity 110 and a punch 130. The blank 110 is formed into a sheet metal part when the die 110 is pushed down to the punch 130 in the direction of the draw axis (shown by an arrow 140). The die 110 has a product design section 102, binder section 106a-b and addendum section 104a-b. The boundary between the addendum section 104a-b and the design surface section 102 is referred to as a trim line 103a-b, while the direct intersection between the addendum sections 104a-b and the binder section 106a-b is referred to as theoretical punch opening line 105a-b. Trim lines are mostly enclosed and there can be more than one enclosed trim lines in a sheet metal part. It is possible to have more than one hundred enclosed trim lines for forming a complex sheet metal part.

Product design surface is the desired pattern/shape of a sheet metal part at the end of the forming process followed by a trimming operation. Binder section is configured for holding the blank during the forming process. Addendum section provides a buffer or transition zone between the product design surface section and the binder section. After the blank is shaped by the punch, the sheet metal part is cut out along the enclosed trim lines.

A well or properly designed addendum section of a die results into defect-free (i.e., wrinkling, stretching and/or thinning are within the design limit) sheet metal products or parts. Therefore, it is vital to have a good addendum section designed as quickly as possible in a production environment. Traditionally, before the proliferation of computer aided design (CAD) and computer aided engineering (CAE) analysis (e.g., finite element analysis (FEA)), addendum section design has been expensive and tedious because a prototype must be made to verify a trial design. Later, designing of addendum section is aided using computer-implemented methods, which include using CAD to generate a surface model of the addendum section and then using FEA to simulate the metal forming process. A computer simulation is used to verify whether a die having particular addendum surface can actually produce a desired product. However, prior art approaches of creating a surface model have shortcomings. One of the approaches requires user (i.e., designer) to fit a curve through a number cross-section profiles, which is cumbersome and time consuming.

It would therefore be desirable to have an efficient method for creating a computerized numerical model representing addendum section to be used in a computer simulation of sheet metal forming of a sheet metal part or product.

### BRIEF SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

The present invention is directed to an improved method of creating a computerized numerical model representing addendum section. The computerized numerical model is suitable for a computer simulation of sheet metal forming process using computer aided engineering analysis (e.g., finite element analysis).

According to one aspect of the present invention, an addendum section is bounded by one of the enclosed trim lines of product design surface and binder opening line of the binder section on the die-face. For a particular sheet metal part to be formed, the product design surface and associated enclosed trim lines are defined. Additionally, a die's binder section for clamping down a blank is located at known positions. Computerized numerical model of an addendum section is created by placing a plurality of surface patches at disjoint locations between an enclosed trim line and corresponding binder opening line. Each surface patch is bounded with top and bottom edges coincided with the enclosed trim line and the binder opening line, respectively. Each surface patch is further bounded with two side edges connecting corresponding ends of the top and bottom edges.

To ensure a continuously smooth transition between the product design surface and the binder surface, a number of parameters are adjusted for each surface patch to obtain a desired surface geometry. The desired surface geometry includes continuous smooth transition of the entire surface and a tangential transition with the product design surface geometry and with the binder surface geometry. Any gap between a neighboring pair of surface patches is filled with a filler patch using a blending procedure that ensures continuous smooth transition from two neighboring side edges of the neighboring pair. Additionally, the top and bottom edges of the filler surface patch are matched exactly to corresponding section of the enclosed trim line and the binder opening line, respectively. Furthermore, continuous smooth transitions at the top and bottom edges are also maintained.

According to another aspect, there are a number of predefined surface patches to be selected to create an addendum section. These predefined surface patches are configured to be adjusted with a set of parameters including, but not limited to, straight segments and/or radial transitions along either vertical side, angle between surface normal vector and a plane normal of the deep draw axis at various locations on the surface patch, width and/or curvature of horizontal sides, etc.

One of the objects of the present invention is to efficiently verify a die-face design using the improved method to create a computerized numerical model of the die-face design.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1 is a diagram showing an elevation cross-section view of an exemplary set up of a draw die for sheet metal forming;

FIG. 2A is a diagram showing a plan view of an exemplary die face including enclosed trim lines in accordance with one embodiment of the present invention;

FIG. 2B is a diagram showing a portion of the enclosed trim line and binder opening line of an exemplary die face in accordance with the present invention;

FIG. 3 is a flowchart illustrating an exemplary process of creating a computerized numerical model representing an addendum section of a die used in forming of a sheet metal part, according to an embodiment of the present invention;

FIGS. 4A-4C are diagrams illustrating various stages of the exemplary process of creating a computerized numerical model representing addendum section in accordance with one embodiment of the present invention;

FIGS. 5.1-5.3 collectively show an exemplary surface patches that can be used in the exemplary process shown in FIG. 3, according to an embodiment of the present invention;

FIGS. 6.1-6.2 show alternative exemplary surface patches that can be used in the exemplary process shown in FIG. 3, according to another embodiment of the present invention;

FIGS. 7.1-7.4 show other alternative exemplary surface patches that can be used in the exemplary process shown in FIG. 3, according to yet another embodiment of the present invention;

FIGS. 8.1-8.4 show other alternative exemplary surface patches that can be used in the exemplary process shown in FIG. 3, according to still another embodiment of the present invention; and

FIG. 9 is a functional block diagram showing salient components of an exemplary computer, in which an embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Additionally, used herein, the terms “horizontal”, “vertical”, “upper”, “lower”, “top”, “bottom”, “right”, “left”, “front”, “back”, “rear”, “side”, “middle”, “upwards”, and “downwards” are intended to provide relative positions for the purposes of description, and are not intended to designate an absolute frame of reference. Further, the order of blocks in process flowcharts or diagrams representing one or more embodiments of the invention do not inherently indicate any particular order nor imply any limitations in the invention.

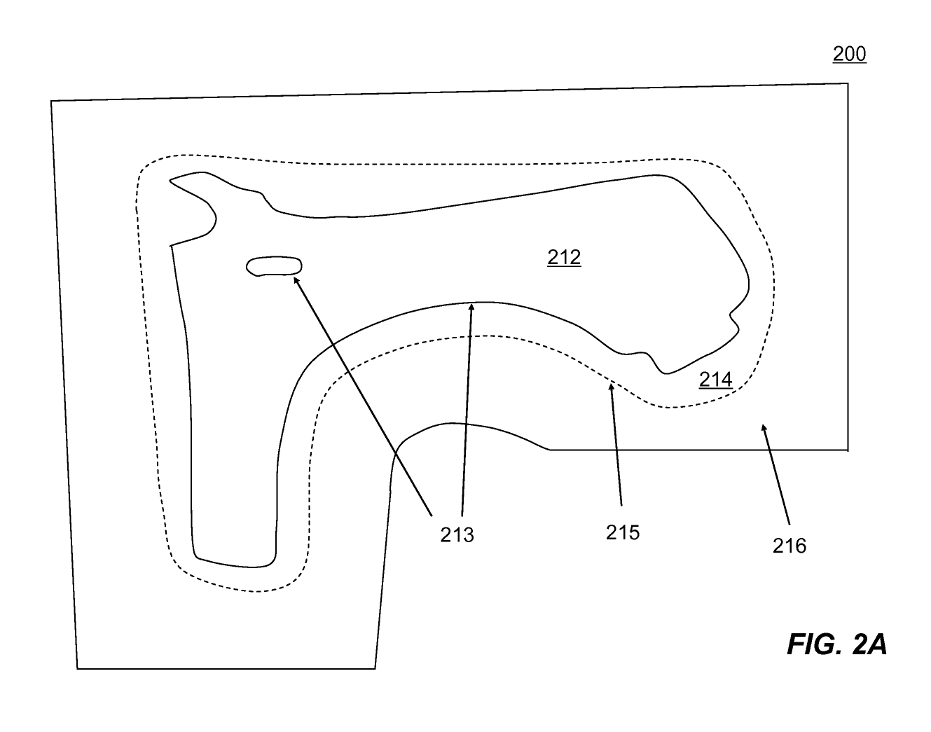

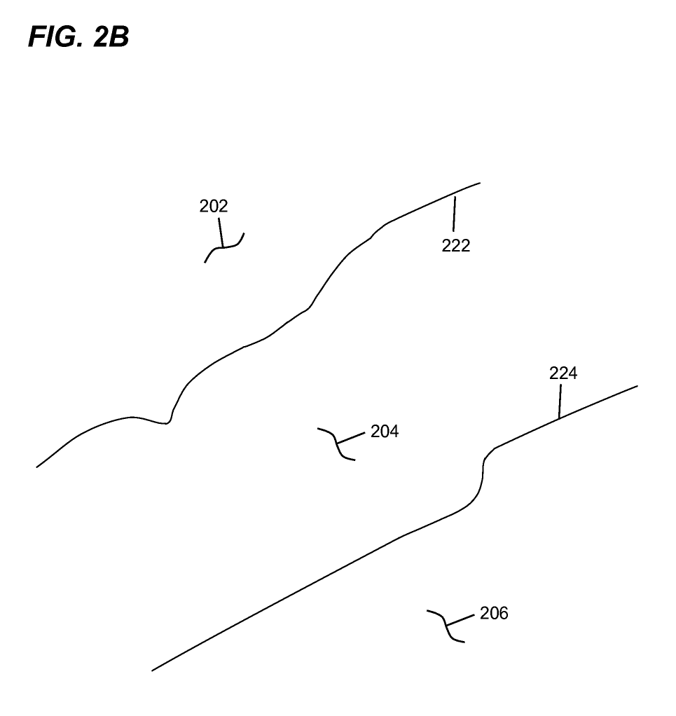

Embodiments of the present invention are discussed herein with reference to FIGS. 2A-9. However, those skilled in the art will readily appreciate that the detailed description given herein with respect to these figures is for explanatory purposes as the invention extends beyond these limited embodiments.

The present invention is directed to an improved method of creating a computerized numerical model representing addendum section. The computerized numerical model is suitable for a computer simulation of a sheet metal forming process using computer aided engineering analysis (e.g., finite element analysis).

Referring first to FIG. 2A, it is shown an exemplary simplified die face 200. Die face 200 includes a part or product design area 212, a binder area 216 and an area 214 to be filled or connected by an addendum section. Two enclosed trim lines 213 and a theoretical punch opening line 215 (dotted line) are also shown.

FIG. 2B is a diagram showing a portion of the enclosed trim line 222 and binder opening line 224 of an exemplary die face (e.g., die face 200). Also shown in FIG. 2B are a product design surface area 202 and a binder area 206. The area 204 between the enclosed trim line 222 and the binder opening line 224 is to be filled with or connected by an addendum section.

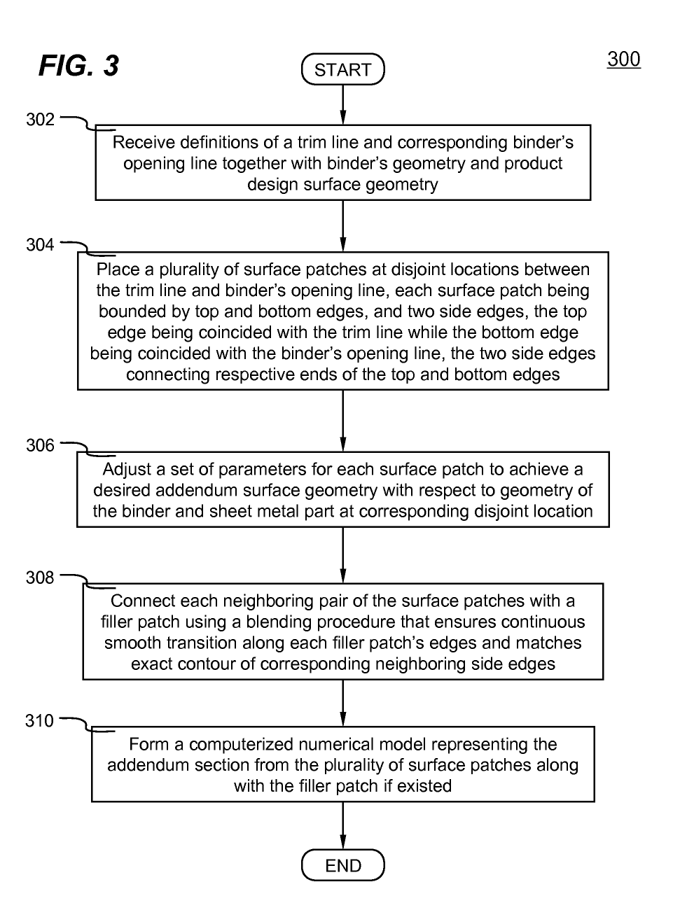

According to an embodiment, FIG. 3 shows an exemplary process 300 of creating a computerized numerical model representing an addendum section of a die for forming of a sheet metal part. Process 300 may be implemented in software and preferably understood with other figures, for example, FIGS. 2A-2B, 4A-4C, 5.1-5.3, 6.1, 6.2, 7.1-7.4 and 8.1-8.4.

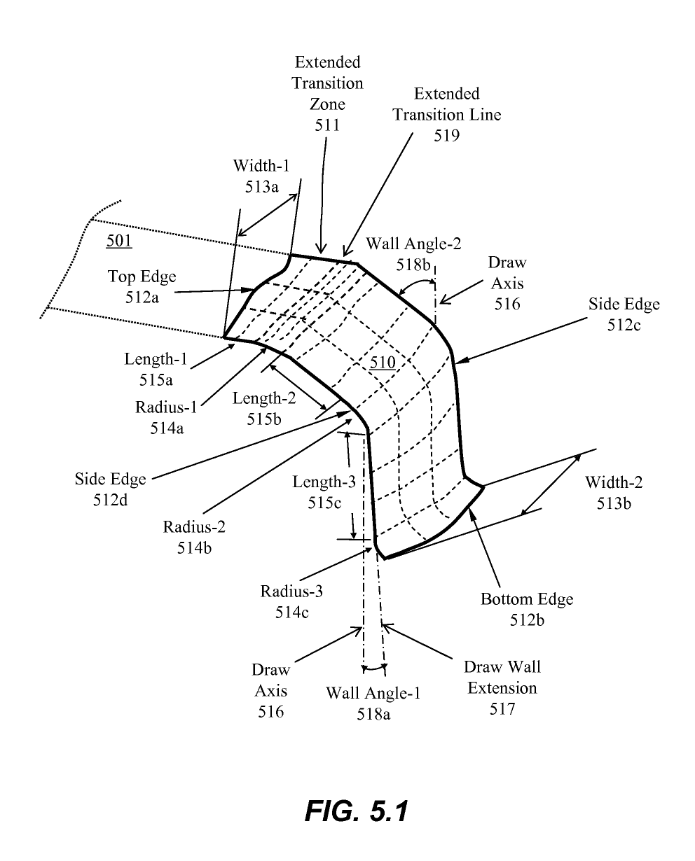

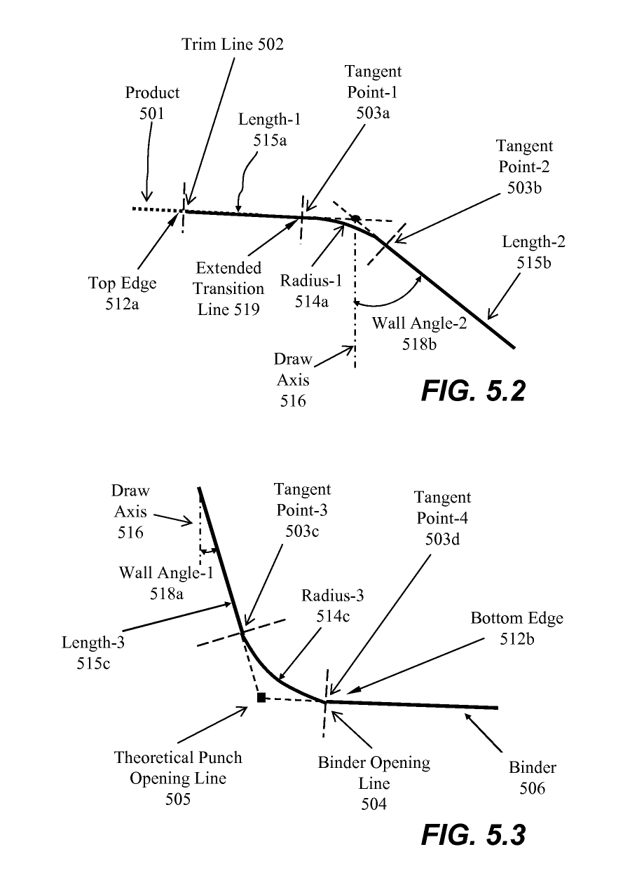

Process 300 starts at step 302 by receiving definitions of an enclosed trim line or one of more than one enclosed trim lines 222 and binder opening line 224 together with the binder's geometry 206 and the sheet metal part's design surface geometry 202. These definitions provide a user (i.e., die-face designer, process engineer, or CAE analyst) with basic information to create a surface geometry of an addendum section. Next, at step 304, a plurality of surface patches is placed at disjoint locations between the enclosed trim line and the binder opening line. The surface patches are not overlapped with one another. Each surface patch can be chosen from a number of predefined surface patches. Each of the surface patches is then adjusted via a set of parameters to achieve a desired addendum surface geometry at its disjoint location at step 306. Details of the predefined surface patches and adjustable parameters are described below in descriptions of exemplary surface patches shown in FIGS. 5.1-5.3.

In step 308, process 300 connects each neighboring pair of the surface patches with a filler patch using a blending procedure that ensures continuous smooth transition along each filler patch's edges and matches exact contour of corresponding neighboring side edges of the neighboring pair. In certain situations, filler patch is not required when the neighbor pair forms a seamless surface. Then a computerized numerical model of the addendum section is created from the plurality of the surface patches along with all of the filler patches at step 310.

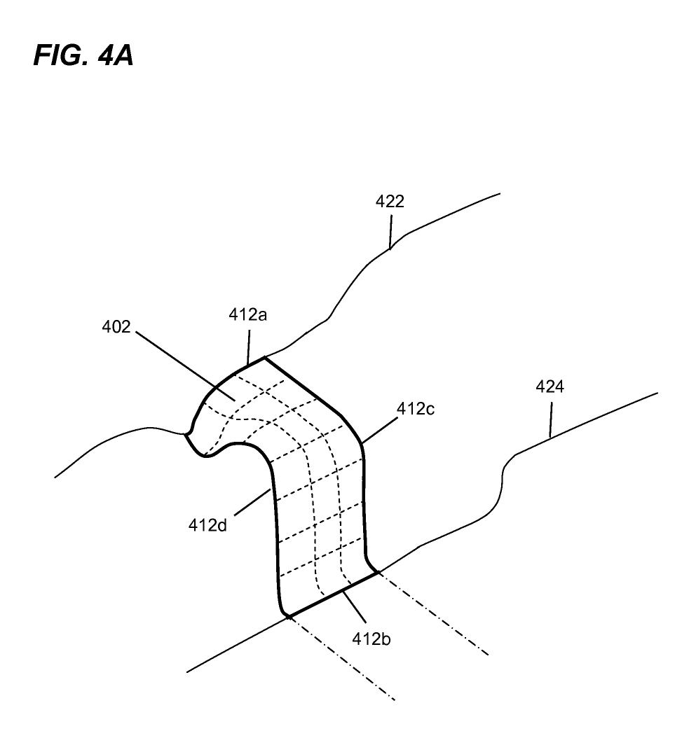

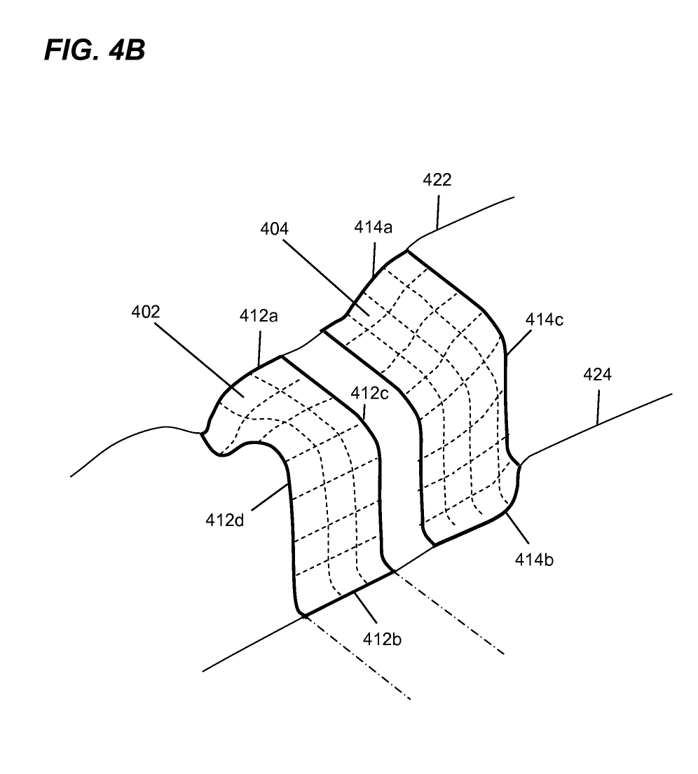

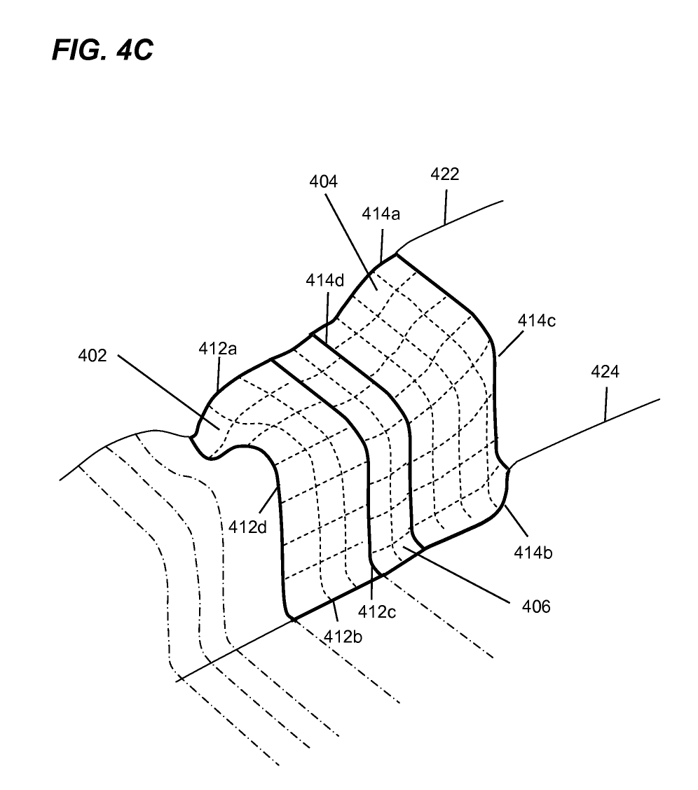

In an alternative embodiment shown in FIGS. 4A-4C, a first surface patch 402 is placed between an enclosed trim line 422 and a binder opening line 424 at a first location. The first surface patch 402 is bounded by top edge 412a and bottom edge 412b, and two side edges 412c-d. Top edge 412a coincides with the enclosed trim line 422 while the bottom edge 412b coincides with the binder opening line 424. Continuous smooth transitions are maintained both at the top and the bottom edges 412a-b with the product and the binder, respectively. Two side edges 412c-d connect corresponding ends of the top and bottom edges 412a-b. A set of parameters for the first surface patch 402 is then adjusted to obtain a desired surface geometry. Exemplary parameters include, but are not limited to, one or more radii and one or more straight segment lengths along two side edges, width and curvature of top and bottom edges, and one or more wall angles with respect to the draw axis.

The first geometric requirement for the first surface patch 402 is to have a smooth continuous transition or tangential transitional at top edge with the product or part design surface. To achieve the first requirement, a number of parameters may be adjusted, for example, surface normal at various locations, side edges' radii near the top edge 412a, extended transitional zone, etc. The second requirement is to keep tangential transition at the bottom edge 412b from the binder section. To achieve the second requirement, similar adjustments of parameters are required. However, any adjustment to achieve the second requirement must not violate the first requirement—keeping tangential transition at the top edge 412a.

Once the first surface patch 402 has been adjusted to a desired surface geometry, a second surface patch 404 is placed at a second location between the enclosed trim line 422 and the binder opening line 424. The first and second locations are disjoint. In other words, the first surface patch 402 and the second surface patch 404 are not overlapped. The second surface patch 404 has top edge 414a, bottom edge 414b and two side edges 414c-d similar to the first surface patch 402 as shown in FIG. 4B. The second surface patch 404 is also adjusted under the same requirements for the first surface patch 402.

When a gap exists between the first and second surface patches 402-404, a third surface patch, filler patch 406, is created by a blending procedure connecting the first and the second surface patches 402-404 (i.e., a pair of neighboring surface patches). The filler patch 406 matches its side edges to respective neighboring side edges of the neighboring pair. In FIG. 4C, the neighboring side edges are side edge 412c of the first surface patch 402 and side edge 414d of the second surface patch 404. Surface geometry of an addendum is obtained from the plurality of the surface patches (e.g., first and second surface patches 402-404) and the filler patch (e.g., third patch 406). All edges of the filler patch 406 are kept tangent with respective neighboring surfaces.

A computerized numerical model of the addendum may be a finite element method (FEM) grid model or computer aided design surface model. However, grid lines (dotted lines bordered by thick solid lines within the surface patches) shown in FIGS. 4A-4C are for showing surface contour of the addendum and may or may not be related to a FEM grid model. Furthermore, these grid lines are exemplary, other grid patterns can also be used.

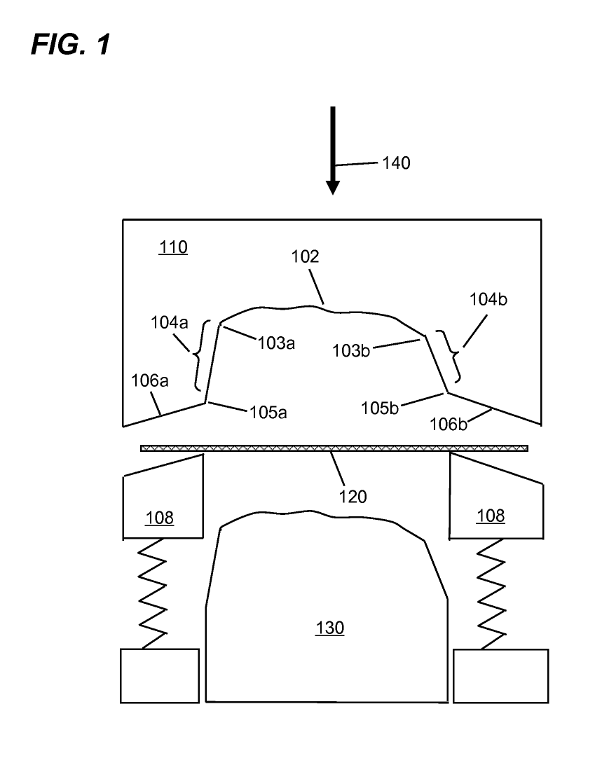

FIGS. 5.1-5.3 collectively show a set of parameters for an exemplary surface patch 510 that can be used for process 300 in accordance with one embodiment of the present invention. FIG. 5.1 shows a surface patch 510 bordered by top edge 512a, bottom edge 512b and two side edges 512c-d. Top edge 512a coincided with the enclosed trim line 502 (shown as line 422 in FIGS. 4A-4C) is a boundary between product design surface 501 and the surface patch 510 (i.e., a portion of addendum). An adjustable extended transition zone 511 is located between top edge 512a and extended transition line 519. The top edge 512a may be curved depending upon the geometry of the product design surface 501 of the sheet metal part. An exemplary set of adjustable parameters along side edge 512d is shown as a number of straight segment lengths (“Length-1” 515a, “Length-2” 515b and “Length-3” 515c), radii (“Radius-1” 514a, “Radius-2” 514b and “Radius-3” 514c) and two wall angles (i.e., an angle “Wall Angle-1” 518a between draw axis 516 and draw wall extension 517, and “Wall Angle-2” 518b). Draw axis 516 is the direction 140 of the draw die 110 pressed onto the punch 130 shown in FIG. 1. Additionally, along side edge 512c, the same or a different set of adjustable parameters may be used. Furthermore, the width. “Width-1” 513a, at the top edge 512a and the width. “Width-2” 513b, at the bottom edge 512b are also adjustable as members of the set of parameters.

FIG. 5.2 shows a cross-sectional view of details of an example of continuous smooth transition in and around the transition zone 511 and top portion of the surface patch 510. “Radius-1” 514a is located between two tangent points “Tangent Point-1” 503a and “Tangent Point-2” 503b at the extended transition zone 511 and the surface patch 510 (portion of addendum), respectively. For an exemplary continuous smooth transition at the bottom edge 512b (coincided with binder opening line 505 (line 424 in FIGS. 4A-4C)), a cross-sectional view is shown in FIG. 5.3. “Radius-3” 514c is located between two tangent points “Tangent Point-3” 503c and “Tangent Point-4” 503d at the surface patch 510 (portion of addendum) and the binder section 506, respectively. The intersection of tangential extensions of addendum and the binder is referred to as theoretical punch opening line 505.

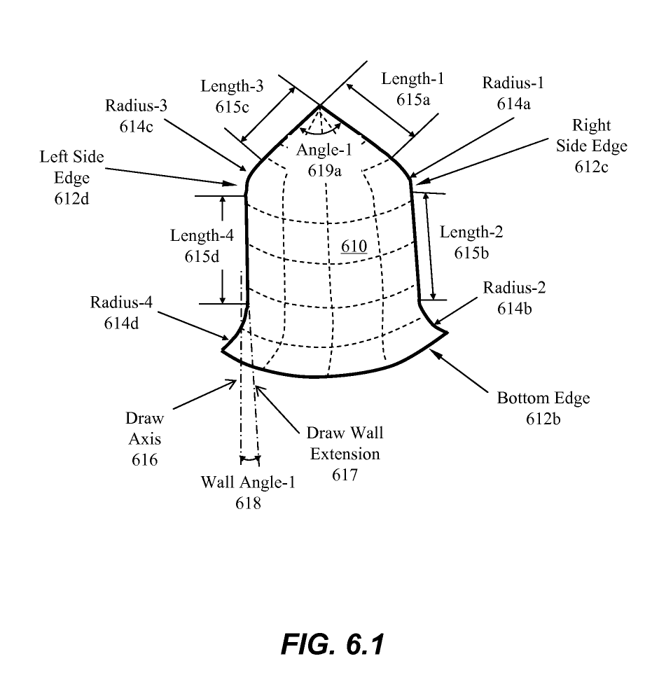

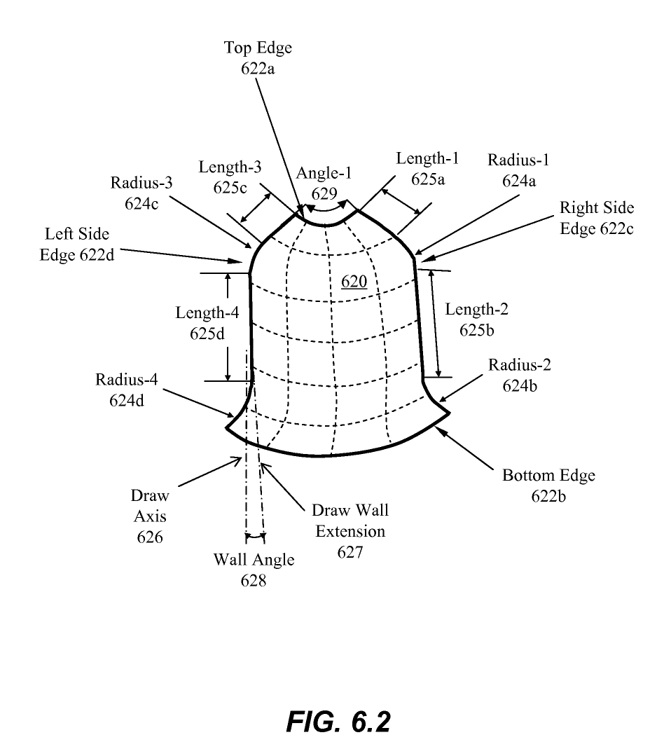

FIGS. 6.1-6.2 show alternative exemplary surface patches that can be used in process 300, according to an embodiment of the present invention. Surface patch 610 is bordered by right side edge 612c and left side edge 612d and bottom edge 612b. The right side edges 612c is formed by a set of adjustable parameters of two straight segment lengths (“Length-1” 615a, and “Length-2” 615b) and two radii (“Radius-1” 614a and “Radius-2” 614b). Similarly, the left side edge 612d is formed by adjustable parameters: “Length-3” 615c, “Length-4” 615d, “Radius-3”, 614c and “Radius-4” 614d. A unique parameter for the surface patch 610 is the intersection angle “Angle-1” 619a of the right and left side edges 612c-d, which converge together at the top of the surface patch 610. In addition, a wall angle “Wall Angle-1” 618 between the draw axis 616 and draw wall extension 617 is another adjustable parameter for surface patch 610.

FIG. 6.2 shows an alternative surface patch 620, which is a more general case of surface patch 610. The difference is the right and left side edges 622c-d do not intersect in surface patch 620. As a result, surface patch 620 is bordered by top edge 622a, bottom edge 622b, right side edges 622c and left side edges 622d. The set of adjustable parameters for forming surface patch 620 is the same as the one for surface patch 610.

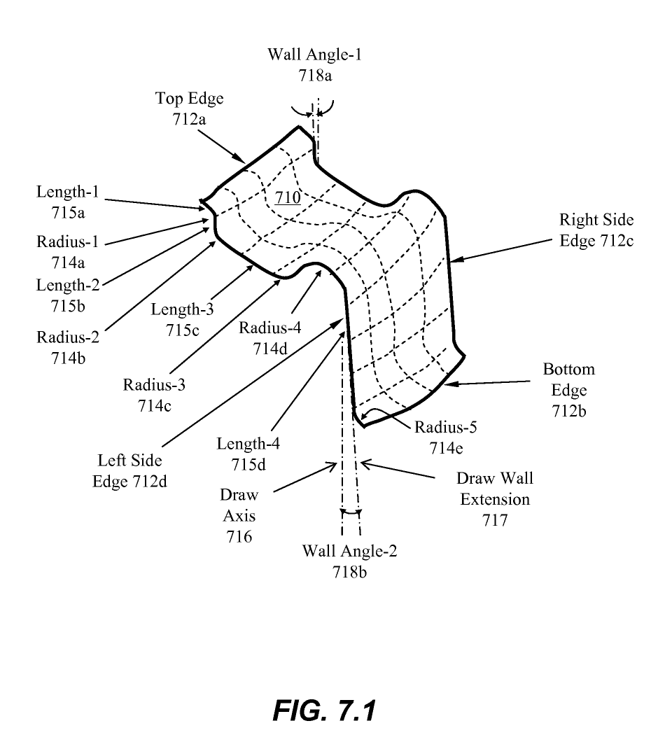

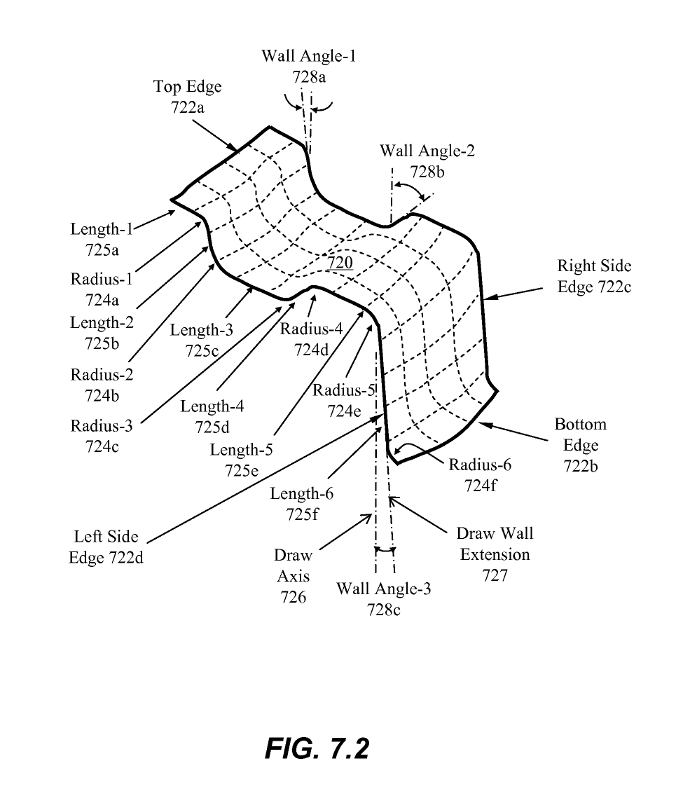

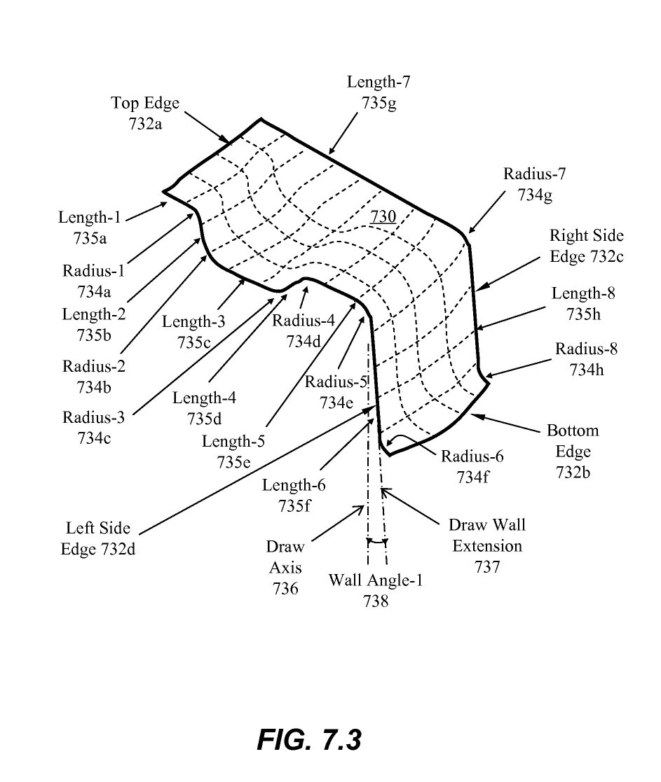

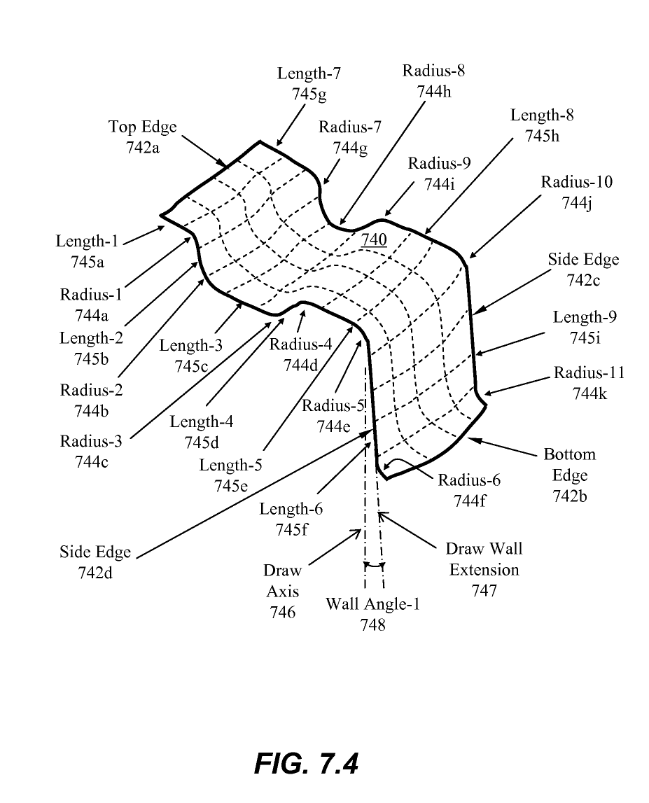

FIGS. 7.1-7.4 show other alternative exemplary surface patches that can be used in process 300, according to another embodiment of the present invention. Surface patch 710 is bordered by top edge 712a, bottom edge 712b, right side edge 712c and left side edge 712d. Similar to all previous surface patches, a set of adjustable parameters is used for forming the surface patch 710. Adjustable parameters include two wall angles (“Wall Angle-1” 718a and “Wall Angle-2” 718b), and five radii (“Radius-1”, “Radius-2”, “Radius-3”, “Radius-4”, “Radius-5” 714a-e) and four straight segment lengths (“Length-1”, “length-2”, “Length-3”, “Length-4” 715a-d) for forming the left side edge 712d and similar ones for the right side edge 712c (parameters not shown).

Surface patch 720 is similar to surface patch 710 except surface patch 720 has three wall angles (“Wall Angle-1” 728a, “Wall Angle-2” 728b and “Wall Angle-3” 728c) instead of two and one additional radius and two straight segment length for forming the side edges 722c-d.

Surface patches 730 and 740 are variations to surface patch 720. Instead of having a symmetrical set of adjustable parameters for both side edges, two side edges are different in surface patches 730 and 740. For surface patch 730, there are six straight segment lengths and six radii for the left side edge 732d, while only two of each for the right side edges 732c. For surface patch 740, the right side edge 742c has three straight segment lengths (“Length-7” 745g, “Length-8” 745h and “Length-9” 745i) and five radii (“Radius-7” 744g, “Radius-8” 744h, “Radius-9” 744i, “Radius-10” 744j and “Radius-11” 744k), while the left side edge 742d has six segment lengths and radii. Surface patches 730 and 740 are referred to as transitional surface patch, because a continuous smooth transition from one side edge to another is required due to difference of the two side edges.

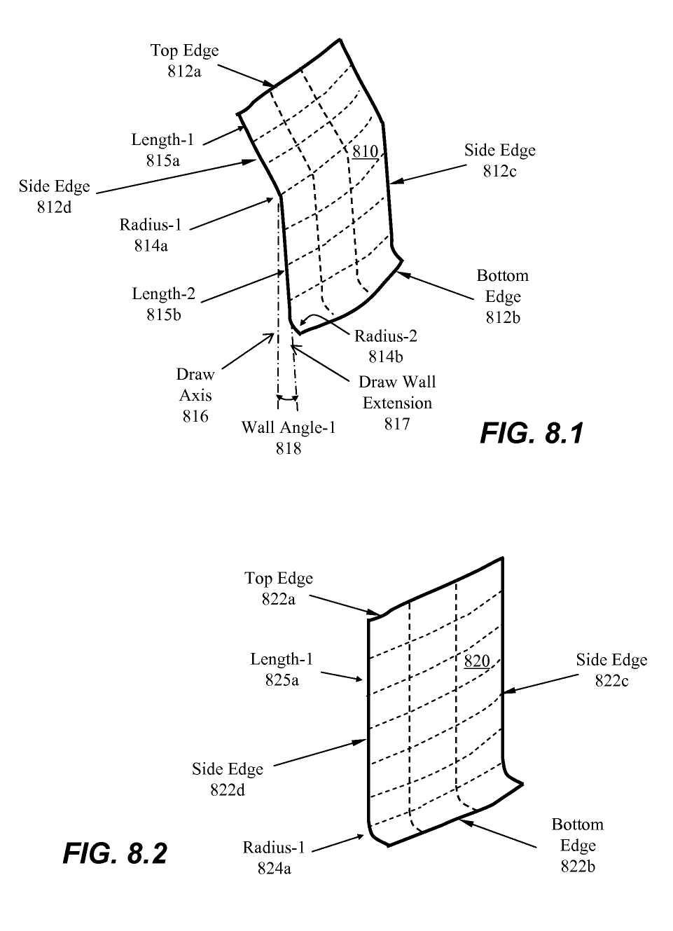

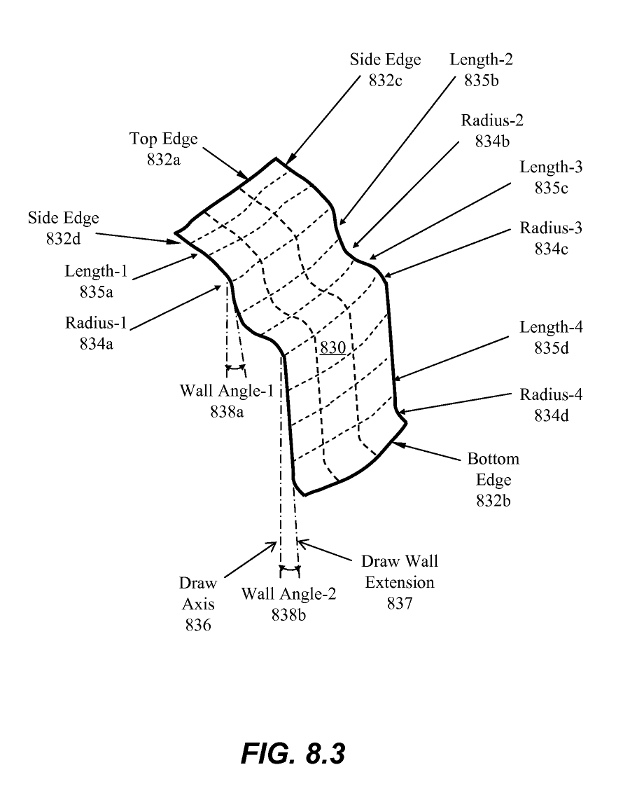

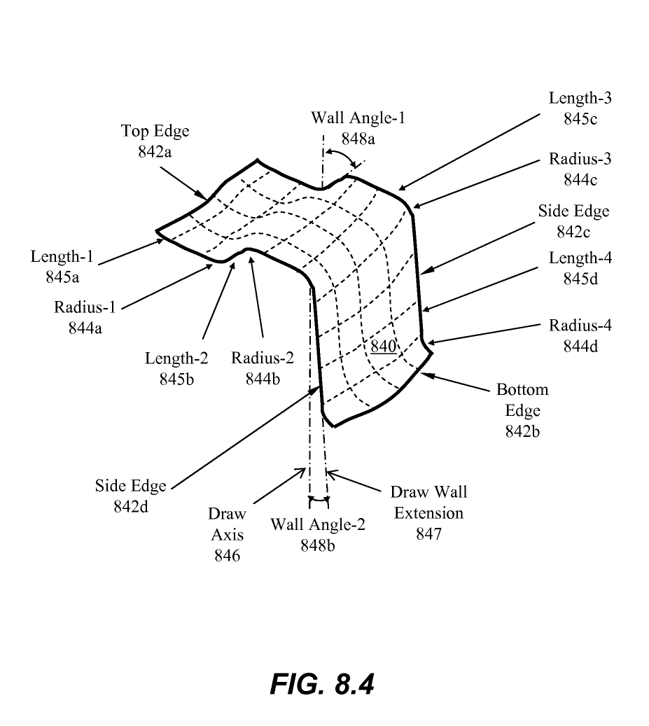

Referring now to FIGS. 8.1-8.4, there are shown alternative exemplary surface patches that can be used in process 300, according to yet another embodiment of the present invention. Surface patch 810 is bordered by top edge 812a, bottom edge 812b and two side edges 812c-d. The set of adjustable parameters includes a wall angle (“Wall Angle-1” 818), two straight segment lengths (“Length-1” 815a and “Length-2” 815b) and two radii (“Radius-1” 814a and “Radius-2” 814b) for each side edge. Additionally, surface patch 820 is a special case for surface patch 810. Only one straight segment length “Length-1” 825a and one radius “Radius-1” 824a is required. Finally, surface patch 830 and surface patch 840 are other variations of surface patch 810.

In FIGS. 5.1, 6.1-6.2, 7.1-7.4 and 8.1-8.4, dotted lines within the surface patches are shown for the purpose of easier visualization of surface contours.

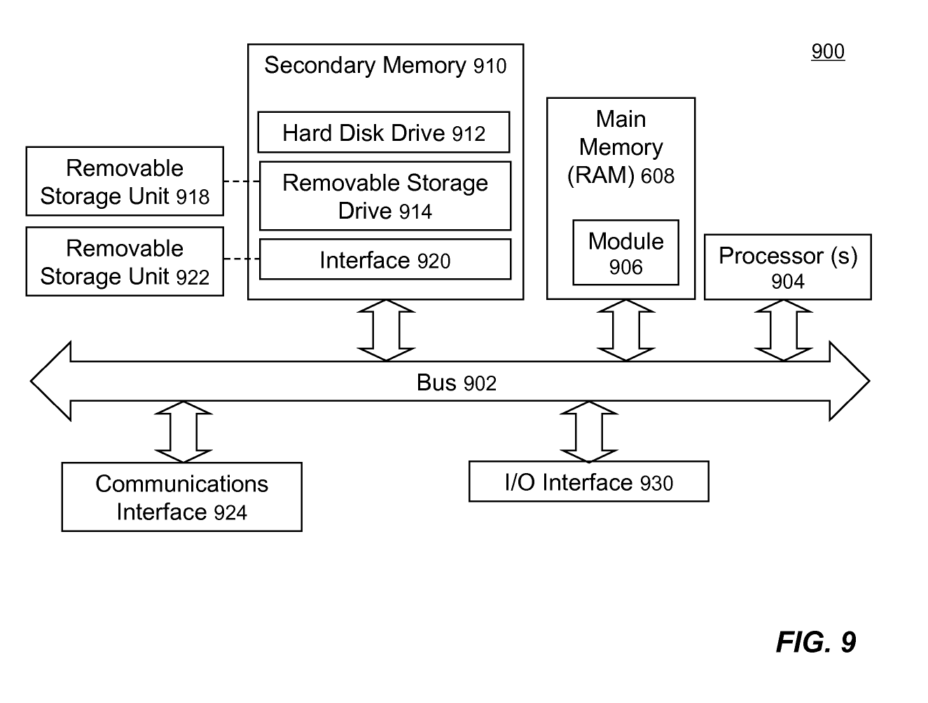

According to one aspect, the present invention is directed towards one or more computer systems capable of carrying out the functionality described herein. An example of a computer system 900 is shown in FIG. 9. The computer system 900 includes one or more processors, such as processor 904. The processor 904 is connected to a computer system internal communication bus 902. Various software embodiments are described in terms of this exemplary computer system. After reading this description, it will become apparent to a person skilled in the relevant art(s) how to implement the invention using other computer systems and/or computer architectures.

Computer system 900 also includes a main memory 908, preferably random access memory (RAM), and may also include a secondary memory 910. The secondary memory 910 may include, for example, one or more hard disk drives 912 and/or one or more removable storage drives 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc. which is read by and written to by removable storage drive 914. As will be appreciated, the removable storage unit 918 includes a computer usable storage medium having stored therein computer software and/or data.

In alternative embodiments, secondary memory 910 may include other similar means for allowing computer programs or other instructions to be loaded into computer system 900. Such means may include, for example, a removable storage unit 922 and an interface 920. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 922 and interfaces 920 which allow software and data to be transferred from the removable storage unit 922 to computer system 900. In general, Computer system 900 is controlled and coordinated by operating system (OS) software, which performs tasks such as process scheduling, memory management, networking and I/O services.

There may also be a communications interface 924 connecting to the bus 902. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928 which may be electronic, electromagnetic, optical, or other signals capable of being received by communications interface 924. The computer 900 communicates with other computing devices over a data network based on a special set of rules (i.e., a protocol). One of the common protocols is TCP/IP (Transmission Control Protocol/Internet Protocol) commonly used in the Internet. In general, the communication interface 924 manages the assembling of a data file into smaller packets that are transmitted over the data network or reassembles received packets into the original data file. In addition, the communication interface 924 handles the address part of each packet so that it gets to the right destination or intercepts packets destined for the computer 900. In this document, the terms “computer program medium” and “computer usable medium” are used to generally refer to media such as removable storage drive 914, and/or a hard disk installed in hard disk drive 912. These computer program products are means for providing software to computer system 900. The invention is directed to such computer program products.

The computer system 900 may also include an input/output (I/O) interface 930, which provides the computer system 900 to access monitor, keyboard, mouse, printer, scanner, plotter, and alike.

Computer programs (also called computer control logic) are stored as application modules 906 in main memory 908 and/or secondary memory 910. Computer programs may also be received via communications interface 924. Such computer programs, when executed, enable the computer system 900 to perform the features of the present invention as discussed herein. In particular, the computer programs, when executed, enable the processor 904 to perform features of the present invention. Accordingly, such computer programs represent controllers of the computer system 900.

In an embodiment where the invention is implemented using software, the software may be stored in a computer program product and loaded into computer system 900 using removable storage drive 914, hard drive 912, or communications interface 924. The application module 906, when executed by the processor 904, causes the processor 904 to perform the functions of the invention as described herein.

The main memory 908 may be loaded with one or more application modules 906 that can be executed by one or more processors 904 with or without a user input through the I/O interface 930 to achieve desired tasks. In operation, when at least one processor 904 executes one of the application modules 906, the results are computed and stored in the secondary memory 910 (i.e., hard disk drive 912). The status of the computer simulation of sheet metal forming process (e.g., finite element analysis results) is reported to the user via the I/O interface 930 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas one enclosed trim line has been shown and described in the Specification, there can be more than one enclosed trim line on a die face. In a complex part, more than one hundred enclosed trim lines are not uncommon. Addendum between any one of the enclosed trim lines and binder opening line can be designed with the process described according to an embodiment of the present invention. Further, whereas only two surface patches and one filler patch has been shown and described; there can be more than two surface patches with more than one filler patches to practice the present invention. Finally, whereas exemplary predefined surface patches in FIGS. 5.1, 6.1-6.2, 7.1-7.4 and 8.1-8.3 have been shown and described, other predefined surface patches may be used to achieve the equivalent. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of creating a computerized numerical model representing an addendum section of a die for forming of a sheet metal part, the sheet metal part is formed from a blank sheet metal being pushed onto a punch by the die while the blank sheet metal is clamped down by a binder, the sheet metal part is then cut out along one or more enclosed trim lines and the addendum section is located between one of the enclosed trim lines and the binder opening line, said method comprising:
receiving definitions of an enclosed trim line and corresponding binder opening line together with the binder's geometry and the sheet metal part's design surface geometry;
placing a plurality of surface patches at disjoint locations between the enclosed trim line and the binder opening line;
adjusting a set of parameters for said each of the surface patches to obtain an addendum surface geometry at the corresponding disjoint location, said addendum surface geometry including a continuous smooth transition from both the binder's geometry and the sheet metal part's design surface geometry;
connecting each neighboring pair of the surface patches with a filler patch using a blending procedure, if a gap exists between said each neighboring pair; and
obtaining a computerized numerical representation of the addendum section from the plurality of surface patches and the filler patch, wherein said computerized numerical representation is configured to be used in a computer simulation of a sheet metal forming process to verify whether the addendum section has been properly designed for producing the sheet metal part.

2. The method of claim 1, wherein said each of the surface patches is bounded by top and bottom edges, and a pair of side edges, the top edge being coincided with the enclosed trim line while the bottom edge being coincided with the binder opening line, the side edges connecting respective ends of the top and bottom edges.

3. The method of claim 2, wherein the set of parameters includes at least one curvature and one or more straight segment lengths at distinct locations along each of the side edges.

4. The method of claim 2, wherein the set of parameters includes a width of the top edge and a width of the bottom edge.

5. The method of claim 2, wherein the set of parameters includes a wall angle with respect to draw axis at a particular location of said each of the surface patches, the drawing axis being the punch's direction in the sheet metal forming process.

6. The method of claim 2, further comprises keeping a tangential transition at the top edge with the sheet metal part's geometry by adjusting the set of parameters.

7. The method of claim 6, further comprises keeping a tangential transition the bottom edge with the binder's geometry by adjusting the set of parameters without changing the tangential transition at the top edge.

8. The method of claim 2, wherein said blend procedure ensures continuous smooth transition along said filler patch's edges and matches exact contour of respective neighboring side edges of the neighboring pair of the surface patches.

9. The method of claim 1, wherein said each of the surface patches is bounded by a top vertex, a bottom edge and a pair of side edges, the top vertex being located on the enclosed trim line while the bottom edge being coincided with the binder opening line, the side edges connecting respective ends of the top and bottom edges.

10. A method of creating a computerized numerical model representing an addendum section of a die for forming of a sheet metal part, the sheet metal part is formed from a blank sheet metal being pushed onto a punch by the die while the blank sheet metal is clamped down by a binder, the sheet metal part is then cut out along one or more enclosed trim lines and the addendum section is located between one of the enclosed trim lines and the binder opening line, said method comprising:
receiving definitions of an enclosed trim line and corresponding binder opening line together with the binder's geometry and the sheet metal part's design surface geometry;
placing a first surface patch at a first location between the enclosed trim line and the binder opening line;
adjusting a set of parameters of the first surface patch to obtain a first partial addendum surface geometry at the first location, said first partial addendum surface geometry being a continuous smooth transition from both the binder's geometry and the sheet metal part's design surface geometry;
placing a second surface patch at a second location in the area between the enclosed trim line and the binder opening line, the second location being so selected that the second surface patch does not overlap the first surface patch;
adjusting a set of parameters of the second surface patch to obtain a second partial addendum surface geometry at the second location, said second partial addendum surface geometry being a continuous smooth transition from both the binder's geometry and the sheet metal part's design surface geometry;
connecting the first and the second surface patches with a third surface patch using a blending procedure, if a gap exists between said first and said second surface patches; and
obtaining a computerized numerical representation of the addendum section from the first, second and third surface patches, wherein said computerized numerical representation is configured to be used in a computer simulation of a sheet metal forming process to verify whether the addendum section has been properly designed for producing the sheet metal part.

11. The method of claim 10, wherein said each of the first and second surface patches is bordered by top and bottom edges, and a pair of side edges, the top edge being coincided with the enclosed trim line while the bottom edge being coincided with the binder opening line, the side edges connecting respective ends of the top and bottom edges.

12. The method of claim 11, wherein the set of parameters includes at least one curvature and one or more straight segment lengths at distinct locations along each of the side edges.

13. The method of claim 11, wherein the set of parameters includes a width of the top edge and a width of the bottom edge.

14. The method of claim 11, wherein the set of parameters includes a wall angle with respect to draw axis at a particular location of said each of the surface patches, the drawing axis being the punch's direction in the sheet metal forming process.

15. The method of claim 11, further comprises keeping a tangential transition at the top edge with the sheet metal part's geometry by adjusting the set of parameters.

16. The method of claim 15, further comprises keeping a tangential transition the bottom edge with the binder's geometry by adjusting the set of parameters without changing the tangential transition at the top edge.

17. The method of claim 11, further comprises keeping a tangential transition at the top edge with the sheet metal part's geometry and at the bottom edge with the binder's geometry.

18. The method of claim 11, wherein said blending procedure ensures continuous smooth transition along said third surface patch's edges and matches exact contour of respective neighboring side edges of the first and the second surface patches.

19. A system for creating a computerized numerical model representing an addendum section of a die for forming of a sheet metal part, the sheet metal part is formed from a blank sheet metal being pushed onto a punch by the die while the blank sheet metal is clamped down by a binder, the sheet metal part is then cut out along one or more enclosed trim lines and the addendum section is located between one of the enclosed trim lines and the binder opening line, said system comprising:
an input/output (I/O) interface;
a memory for storing computer readable code for an application module;
at least one processor coupled to the memory, said at least one processor executing the computer readable code in the memory to cause the application module to perform operations of:
receiving definitions of an enclosed trim line and corresponding binder opening line together with the binder's geometry and the sheet metal part's design surface geometry;
placing a first surface patch at a first location between the enclosed trim line and the binder opening line;
adjusting a set of parameters of the first surface patch to obtain a first partial addendum surface geometry at the first location, said first partial addendum surface geometry being a continuous smooth transition from both the binder's geometry and the sheet metal part's design surface geometry;
placing a second surface patch at a second location in the area between the enclosed trim line and the binder opening line, the second location being so selected that the second surface patch does not overlap the first surface patch;
adjusting a set of parameters of the second surface patch to obtain a second partial addendum surface geometry at the second location, said second partial addendum surface geometry being a continuous smooth transition from both the binder's geometry and the sheet metal part's design surface geometry;
connecting the first and the second surface patches with a third surface patch using a blending procedure, if a gap exists between said first and said second surface patches; and
obtaining a computerized numerical representation of the addendum section from the first, second and third surface patches, wherein said computerized numerical representation is configured to be used in a computer simulation of a sheet metal forming process to verify whether the addendum section has been properly designed for producing the sheet metal part.

20. A non-transitory computer readable medium containing computer executable instructions for creating a computerized numerical model representing an addendum section of a die for forming of a sheet metal part, the sheet metal part is formed from a blank sheet metal being pushed onto a punch by the die while the blank sheet metal is clamped down by a binder, the sheet metal part is then cut out along one or more enclosed trim lines and the addendum section is located between one of the enclosed trim lines and the binder opening line by a method comprising:
receiving definitions of an enclosed trim line and corresponding binder opening line together with the binder's geometry and the sheet metal part's design surface geometry;
placing a first surface patch at a first location between the enclosed trim line and the binder opening line;
adjusting a set of parameters of the first surface patch to obtain a first partial addendum surface geometry at the first location, said first partial addendum surface geometry being a continuous smooth transition from both the binder's geometry and the sheet metal part's design surface geometry;
placing a second surface patch at a second location in the area between the enclosed trim line and the binder opening line, the second location being so selected that the second surface patch does not overlap the first surface patch;
adjusting a set of parameters of the second surface patch to obtain a second partial addendum surface geometry at the second location, said second partial addendum surface geometry being a continuous smooth transition from both the binder's geometry and the sheet metal part's design surface geometry;
connecting the first and the second surface patches with a third surface patch using a blending procedure, if a gap exists between said first and said second surface patches; and
obtaining a computerized numerical representation of the addendum section from the first, second and third surface patches, wherein said computerized numerical representation is configured to be used in a computer simulation of a sheet metal forming process to verify whether the addendum section has been properly designed for producing the sheet metal part.
